(19) United States
(12) Patent Application Publication
(10) Pub. No.: US 2011/0210868 A1
(43) Pub. Date: Sep. 1, 2011

(54) PARKING ASSISTANCE APPARATUS

(76) Inventors: Katsutoshi Yano, Kawasaki (JP); Jun Kawai, Kawasaki (JP); Toshiaki Gomi, Kawasaki (JP); Hiroshi Yamada, Kawasaki (JP); Takushi Fujita, Kawasaki (JP)

(21) Appl. No.: 12/871,963

(22) Filed: Aug. 31, 2010

(30) Foreign Application Priority Data
Aug. 31, 2009 (JP) 2009-200163

(51) Int. Cl. G08G 1/14

(52) U.S. Cl. 340/932.2

(57) ABSTRACT

A parking assistance apparatus includes: a generation unit that generates an overhead-view image as seen from a predetermined viewpoint, in accordance with an image captured by at least one image capturing apparatus mounted in a vehicle; and an output unit that superimposes, in the same coordinate system as the overhead-view image generated by the generation unit, an image of the vehicle on the overhead-view image and a predetermined figure at a position a predetermined distance away from the vehicle on the overhead-view image, and outputs the resulting overhead-view image to a display apparatus.

### CROSS-REFERENCE TO RELATED APPLICATIONS

This application is based upon and claims the benefit of priority of the prior Japanese Patent Application No. 2009-200163, filed on Aug. 31, 2009, the entire contents of which are incorporated herein by reference.

### FIELD

The present invention relates to a parking assistance apparatus.

### BACKGROUND

These days, parking assistance systems for reducing a burden on the driver by assisting with a driving operation are known.

For example, there is a system that causes a vehicle to drive itself from a certain position to a parking position if the driver stops the vehicle at the certain position. With such a system, various sensors mounted on the vehicle cooperate with an in-vehicle electronic control unit (ECU), so that a parking space is recognized and a steering operation and an acceleration operation are automatically performed for reverse parking.

In addition, there is a system that allows the driver to observe a video of the surroundings of the vehicle. With this system, images captured by cameras installed at the front, rear, right, and left of the vehicle are combined, an imitated image of the vehicle is superimposed on the resulting combined image, and an overhead-view image, which is an image as seen from above the vehicle, is displayed on a monitor.

Furthermore, Japanese Laid-Open Patent Publication No. 2008-114628 discusses a system that recognizes white lines that represent a parking space displayed on a camera image and displays, on a monitor, guide lines used to guide a vehicle.

### SUMMARY

According to an aspect of the invention, a parking assistance apparatus includes: a generation unit that generates an overhead-view image as seen from a predetermined viewpoint, in accordance with an image captured by at least one image capturing apparatus mounted in a vehicle; and an output unit that superimposes, in the same coordinate system as the overhead-view image generated by the generation unit, an image of the vehicle on the overhead-view image and a predetermined figure at a position a predetermined distance away from the vehicle on the overhead-view image, and outputs the resulting overhead-view image to a display apparatus.

The object and advantages of the invention will be realized and attained by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a functional block diagram of an example of a system structure of a parking assistance system 1;

FIG. 2 is a diagram of an example of a hardware structure of the parking assistance system 1;

FIG. 3 is a schematic diagram of a vehicle in which a parking assistance apparatus is mounted;

FIG. 4 is an example of a flowchart illustrating image display processing in parking assistance processing;

FIG. 5A is an example of an overhead-view image generated according to the flowchart illustrated in FIG. 4;

FIG. 5B is an example of an overhead-view image on which a subject-vehicle image and a parking space figure are superimposed according to the flowchart illustrated in FIG. 4;

FIG. 6A is a diagram of an example of characteristic values of the vehicle used to determine a position a predetermined distance away from the vehicle;

FIG. 6B is a diagram of an example of a coordinate position of each section of the overhead-view image used to determine the position a predetermined distance away from the vehicle;

FIG. 6C is a diagram of an example of calculation performed to determine the position a predetermined distance away from the vehicle;

FIGS. 7A to 7H are diagrams of an example of overhead-view images;

FIG. 8 is a diagram of an example of viewpoint data;

FIG. 9 is a diagram of an example of figure data;

FIG. 10 is a diagram of an example of image data;

FIG. 11A is a diagram of an example of an overhead-view image before a viewpoint is changed;

FIG. 11B is a diagram of an example of a correction-value table for a parking space figure used when a viewpoint is changed;

FIG. 11C is a diagram of an example of an overhead-view image after the viewpoint has been changed;

FIG. 11D is a diagram of an example of calculation for the parking space figure when the viewpoint is changed;

FIG. 12 is a diagram of an example in which a parking space figure is displayed at a position whose vertices are coordinate positions included in a record in the figure data;

FIG. 13 is a diagram of an example in which a parking space figure is displayed at a position the vehicle will reach when the vehicle is rotated by 90 degrees with respect to an initial stop position of the vehicle;

FIG. 14 is a diagram of an example in which a first parking space figure and a second parking space figure are displayed as parking space figures;

FIG. 15A is a diagram of an example of a schematic diagram for determining vertex coordinates of a parking space figure when parking in which the vehicle is driven forward in a direction to the right and the front is performed;

FIG. 15B is a diagram of an example of a relationship between a parking method and a display coordinate-transformation coefficient; and

FIG. 15C is a diagram of an example of calculation performed to determine the position a predetermined distance away from the vehicle when parking in which the vehicle is driven forward in a direction to the right and the front is performed.

### DESCRIPTION OF EMBODIMENTS

However, with the above-described (in the Background section) system that causes a vehicle to drive itself is difficult for beginner drivers and drivers who are not good at parking to drive the vehicle to an appropriate, predetermined position from which the vehicle is caused to park itself. For example, as a condition for causing the system to recognize a parking space, it is necessary to park a vehicle at a predetermined position a predetermined distance away from the parking space. In order to drive the vehicle to a position that satisfies this condition, a predetermined level of driving skills is desired. Especially when the predetermined position is located adjacent to the far side of the vehicle from the driver's seat, the area near the far side may be a blind area for the driver. Thus, it is difficult to drive the vehicle to the appropriate, predetermined position unless the driver has a sense of vehicle control.

Moreover, the above-described system that allows the drive to observe a video of the surroundings of the vehicle simply displays an overhead-view image as seen from above the vehicle on the monitor, and the system does not actively engage in assisting with parking of the vehicle. Thus, there may be cases in which it is difficult to sufficiently assist drivers who are not good at performing a parking operation. For example, a driver needs to determine which position the driver needs to drive the vehicle to, in order to succeed in reverse parking or the like. Thus, it is considered that the above-described system does not sufficiently assist with parking.

Furthermore, the above-described system that displays guide lines on the monitor operates on the condition that white lines that represent a parking space are present. Thus, the above-described system does not function effectively in a parking lot where there are no white lines.

A parking assistance apparatus according to an embodiment is connected, via a network, to at least one camera mounted on a vehicle and a display apparatus that may display an image, and assists with parking the vehicle onto a target parking position. Moreover, the parking assistance apparatus generates an overhead-view image of the surroundings of the vehicle as seen from a predetermined viewpoint, in accordance with an image captured by the at least one camera. The parking assistance apparatus superimposes, in the same coordinate system as the overhead-view image generated, an image of the vehicle on the overhead-view image and a parking space figure at a position a predetermined distance away from the vehicle on the overhead-view image, and outputs the resulting overhead-view image. Here, it is desirable that the parking assistance apparatus superimpose the image of the vehicle and the parking space figure on the overhead-view image in such a manner that a relative position relationship between the vehicle and the parking space figure in the overhead-view image matches a relative position relationship between the vehicle and the target parking position in a real situation, and output the resulting overhead-view image.

As a result, the driver may easily drive the vehicle to an appropriate, predetermined position and start a parking operation for the vehicle from a stop position which has a high percentage of success of parking. Therefore, the above-described parking assistance apparatus may assist the driver to park the vehicle onto a target parking position.

In the following, embodiments will be specifically described with reference to the drawings.

In the following, an example in which a parking operation is performed by using a vehicle in which a parking assistance apparatus according to an embodiment is mounted will be described. The parking assistance apparatus may function as a parking assistance system by being connected to an image capturing apparatus and a display apparatus. For example, a display apparatus used in a car navigation apparatus, a vehicle-mounted television apparatus, or the like may be used as the display apparatus included in the parking assistance system. In this case, the display apparatus may be used by being switched between operating as part of the parking assistance apparatus and operating as part of a car navigation apparatus or the like.

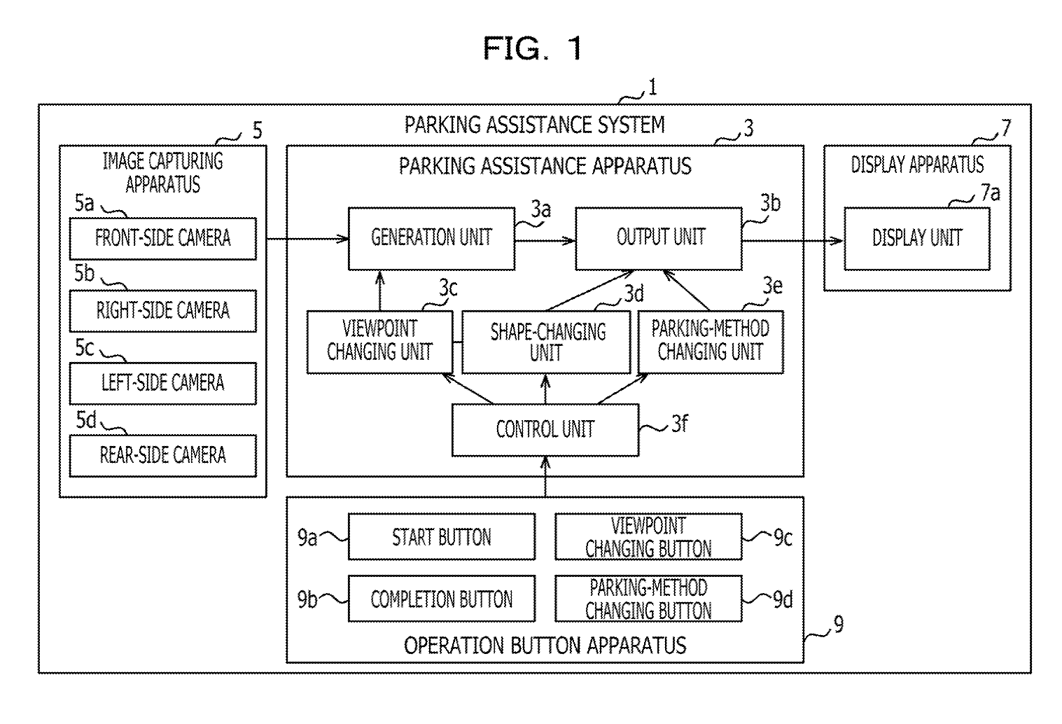

FIG. 1 is a functional block diagram of an example of a system structure of a parking assistance system 1. The parking assistance system 1 includes a parking assistance apparatus 3, an image capturing apparatus 5, a display apparatus 7, and an operation button apparatus 9. The parking assistance apparatus 3, the image capturing apparatus 5, the display apparatus 7, and the operation button apparatus 9 may communicate with one another via an in-vehicle network such as IDB-1394 (IEEE 1394), Media Oriented Systems Transport (MOST), or the like. Here, if an in-vehicle network is not used, the parking assistance apparatus 3 may be connected to the image capturing apparatus 5, the display apparatus 7, and the operation button apparatus 9 in such a manner that the parking assistance apparatus 3 may communicate with the image capturing apparatus 5, the display apparatus 7, and the operation button apparatus 9.

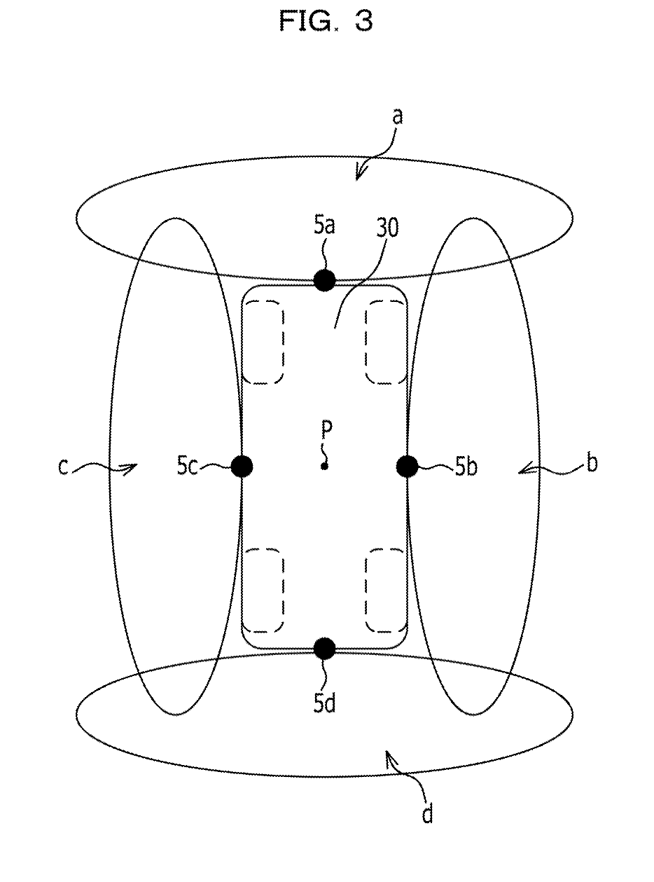

In the parking assistance system 1 illustrated in FIG. 1, the image capturing apparatus 5 includes a front-side camera 5a, a right-side camera 5b, a left-side camera 5c, and a rear-side camera 5d. Each of the cameras 5a-5d is preferably a wide-angle camera whose angle of view is about 180 degrees, and the cameras 5a-5d are arranged at predetermined positions of the vehicle to capture images of the surroundings of the vehicle. For example, FIG. 3 is a schematic diagram of a vehicle 30 in which the parking assistance apparatus 3 is mounted. As illustrated in FIG. 3, images of almost the complete surroundings of the vehicle 30 may be captured by arranging the front-side camera 5a at the front side of the vehicle 30, the right-side camera 5b at the right side, the left-side camera 5c at the left side, and the rear-side camera 5d at the rear side. Images captured by each of the front-side camera 5a, the right-side camera 5b, the left-side camera 5c, and the rear-side camera 5d are transmitted to the parking assistance apparatus 3. Here, the number of cameras is not limited to four and any number of cameras may be used, however, it is preferable that images of almost the complete surroundings of the vehicle 30 be captured using the camera(s).

If the number of cameras is one, a 360-degree camera may be used to capture an image of the surroundings of the vehicle 30 or a wide-angle camera may be rotated to capture an image of the surroundings of the vehicle 30. However, even if a 360-degree camera is arranged on the roof of the vehicle 30, blind areas due to the positional relationship between the 360-degree camera and the vehicle 30 may exist around the vehicle 30. Moreover, if an image of the surroundings of the vehicle 30 is captured by rotating a wide-angle camera, a time delay will exist in the captured image. Therefore, it is desirable that a plurality of wide-angle cameras be used.

In the parking assistance system 1 illustrated in FIG. 1, the parking assistance apparatus 3 includes a generation unit 3a, an output unit 3b, a viewpoint changing unit 3c, a shape-changing unit 3d, a parking-method changing unit 3e, and a control unit 3f. The generation unit 3a of the parking assistance apparatus 3 performs processing for generating (synthesizing) an overhead-view image as seen from a predetermined viewpoint in accordance with images that have been transmitted from the image capturing apparatus 5. The output unit 3b of the parking assistance apparatus 3 superimposes an image of the vehicle 30 and a parking space figure illustrating a target parking position on the overhead-view image in a same coordinate system as the overhead-view image, and performs processing for outputting the resulting image to the display apparatus 7.

In generation of an overhead-view image performed by the generation unit 3a, for example, an image that has been sent from the image capturing apparatus 5 is mapped onto a surface of a predetermined figure having an the image of the vehicle 30, preferably at the center, and an image of the surroundings of the vehicle 30 as seen from a predetermined viewpoint is calculated by performing coordinate transformation. A shape used in mapping may be a bowl shape, a cube shape (a rectangular-parallelepiped shape), or the like, but is not limited thereto.

The control unit 3f of the parking assistance apparatus 3 receives, from the operation button apparatus 9 described below, an input signal corresponding to an instruction input by a driver, and performs processing for giving an instruction to the viewpoint changing unit 3c, the shape-changing unit 3d, or the parking-method changing unit 3e in accordance with this input signal.

Upon reception of an instruction from the control unit 3f, the viewpoint changing unit 3c performs processing for changing the viewpoint from which the overhead-view image is seen. Upon reception of an instruction from the control unit 3f, the shape-changing unit 3d performs processing for changing the shape of the parking space figure to be superimposed on an overhead-view image, when the viewpoint is changed. Upon reception of an instruction from the control unit 3f, the parking-method changing unit 3e performs processing for superimposing the parking space figure on the overhead-view image at a position and in the direction that are appropriate for a parking method.

In the parking assistance system 1 illustrated in FIG. 1, the display apparatus 7 includes a display unit 7a. The display unit 7a displays the overhead-view image on which the image of the vehicle 30 and the parking space figure have been superimposed and that is output from the parking assistance apparatus 3 in such a manner that the driver of the vehicle 30 may observe the overhead-view image. The image of the entire vehicle 30 may not be captured by the vehicle-mounted cameras, and thus a subject-vehicle image that has been captured in advance from a predetermined viewpoint may be prestored as the image of the vehicle 30 in the parking assistance apparatus 3.

In the parking assistance system 1 illustrated in FIG. 1, the operation button apparatus 9 includes a start button 9a, a completion button 9b, a viewpoint changing button 9c, and a parking-method changing button 9d. Each of the start button 9a, the completion button 9b, the viewpoint changing button 9c, and the parking-method changing button 9d provides a corresponding input signal to the control unit 3f of the parking assistance apparatus 3 when the input operation is performed by the driver.

FIG. 1 is a schematic diagram of the parking assistance apparatus 3, and the function units of the parking assistance apparatus 3 may be realized by execution of a program read by a central processing unit (CPU). Here, the program may be a program that may be directly executed by a CPU, a source-form program, a compressed program, an enciphered program, or the like.

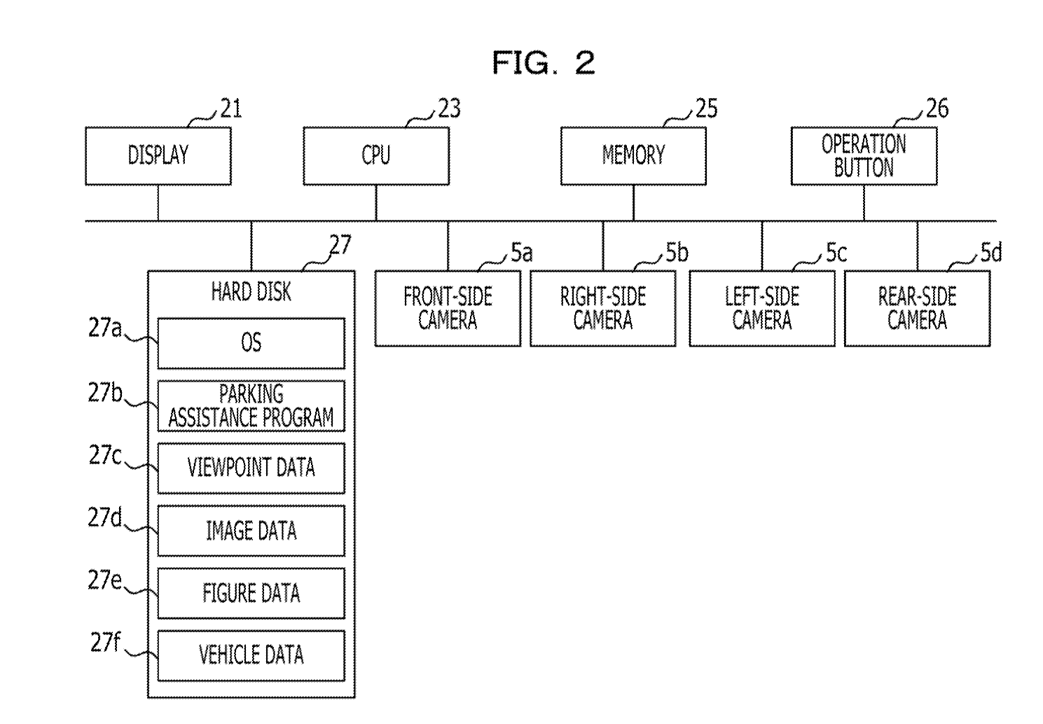

FIG. 2 illustrates an example of a hardware structure of the parking assistance system 1 illustrated in FIG. 1 realized by using a CPU. The parking assistance system 1 includes a display 21, a CPU 23, a memory 25, an operation button 26, a hard disk 27, the front-side camera 5a, the right-side camera 5b, the left-side camera 5c, and the rear-side camera 5d that are connected to one another via the in-vehicle network.

An operating system (OS) 27a, a parking assistance program 27b, viewpoint data 27c, image data 27d, figure data 27e, vehicle data 27f, and the like are recorded in the hard disk 27. Here, all of or part of the OS 27a, parking assistance program 27b, viewpoint data 27c, image data 27d, figure data 27e, and the like may be recorded in the memory 25 instead of the hard disk 27. Moreover, all of or part of the OS 27a, parking assistance program 27b, viewpoint data 27c, image data 27d, figure data 27e, and the like may be recorded on a portable storage medium instead of the hard disk 27.

The CPU 23 executes parking assistance processing, which is processing based on the OS 27a, the parking assistance program 27b, and the like. The display 21 may correspond to the display apparatus 7, and is preferably mounted in the vehicle 30 at a position where the driver may operate. The operation button 26 may correspond to the operation button apparatus 9, and is preferably mounted in the vehicle 30 at a position where the driver may operate.

The generation unit 3a, the output unit 3b, the viewpoint changing unit 3c, the shape-changing unit 3d, and the parking-method changing unit 3e of the parking assistance apparatus 3 illustrated in FIG. 1 may be realized by execution of the parking assistance program 27b performed by the CPU 23.

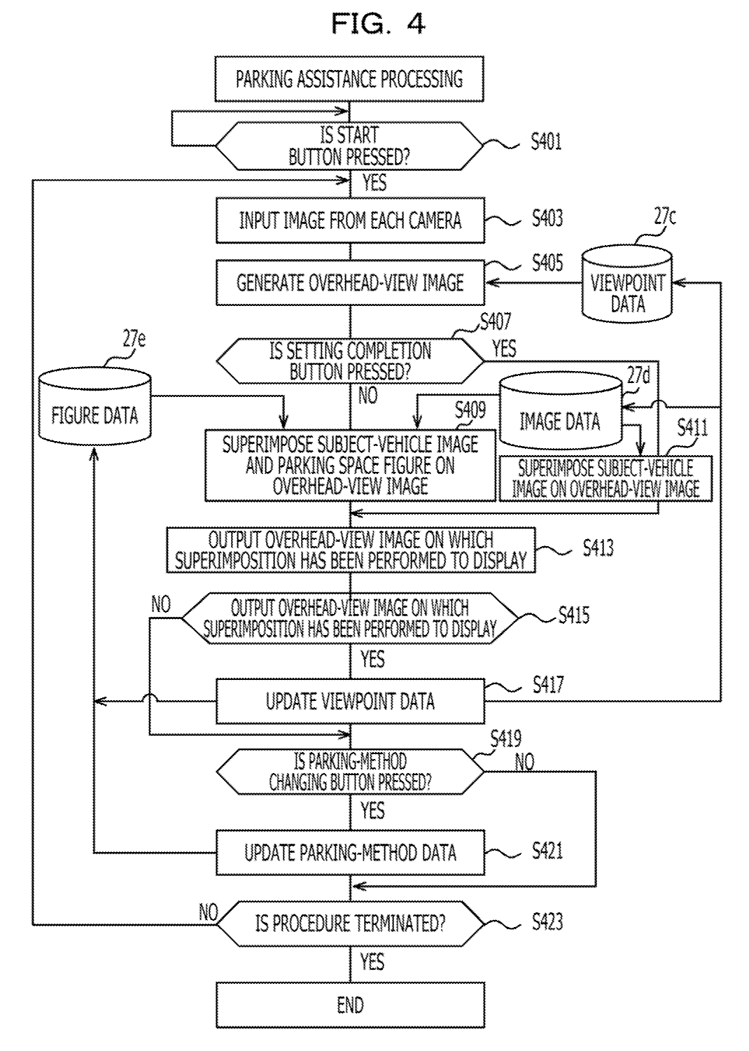

Content of parking assistance processing performed by the parking assistance system 1 will be described with reference to FIGS. 4 to 14. FIG. 4 is an example of a flowchart illustrating image display processing in parking assistance processing. It is assumed that the parking assistance program 27b is executed by the CPU 23 in the parking assistance system 1. In the first embodiment, the parking assistance program 27b is executed upon detection of the start button 9a being pressed; however, the parking assistance program 27b may be started when the shift lever is set to reverse (backward).

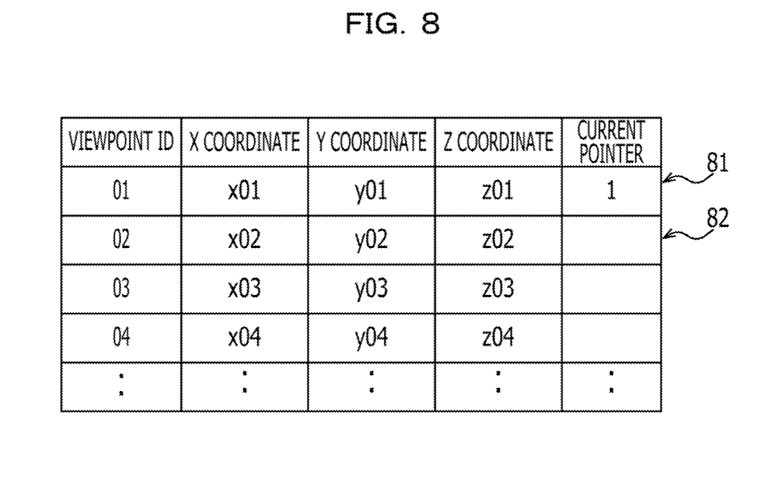

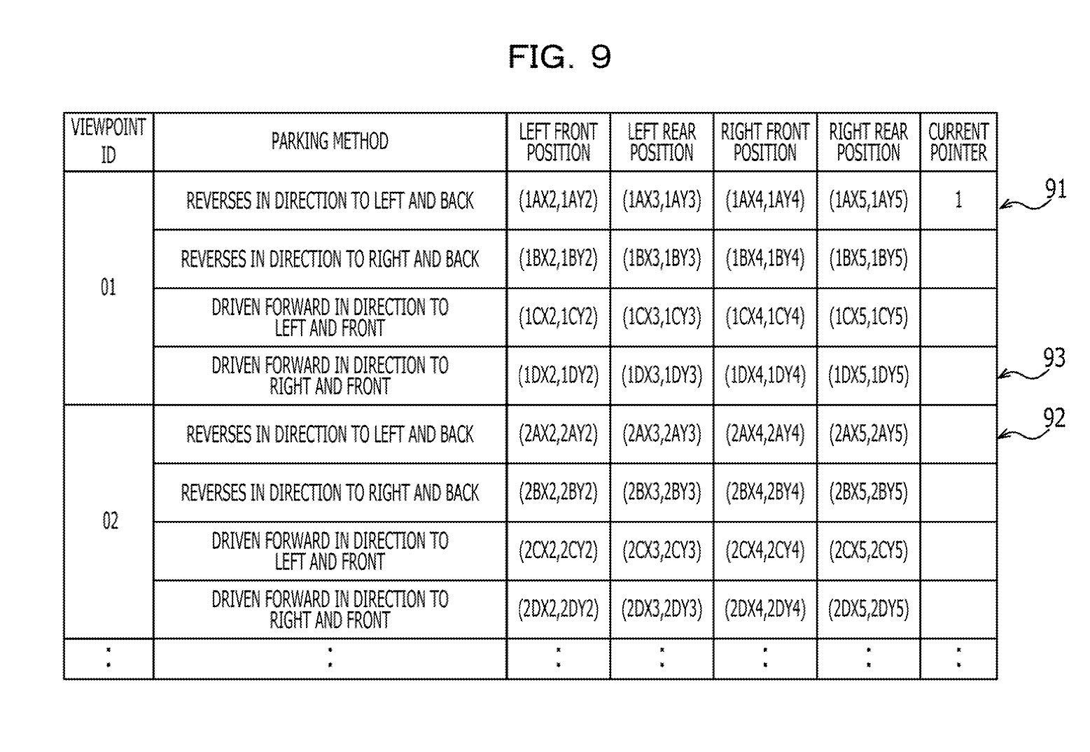

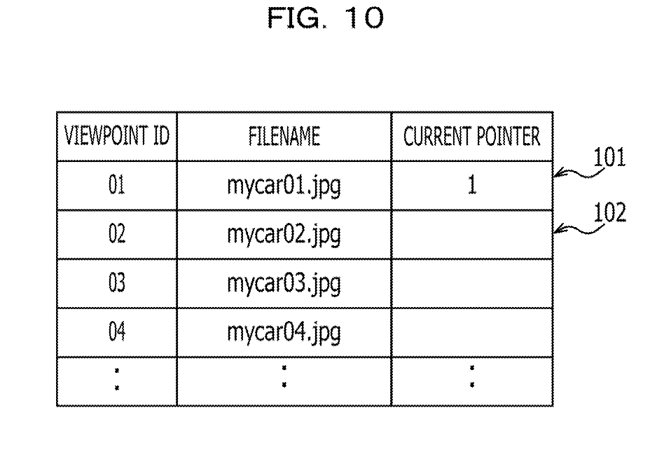

FIG. 8 is a diagram of an example of the viewpoint data 27c. FIG. 9 is a diagram of an example of the figure data 27e. FIG. 10 is a diagram of an example of the image data 27d.

Referring back to FIG. 4, when the vehicle 30 in which the parking assistance system 1 is mounted is in a parking lot, when the driver of the vehicle 30 presses the start button 9a of the parking assistance system 1, the CPU 23 executes the following processing (YES in operation S401).

The generation unit 3a realized by the CPU 23 is input with images of the surroundings of the vehicle 30 captured by the front-side camera 5a, the right-side camera 5b, the left-side camera 5c, and the rear-side camera 5d (operation S403). Here, the hard disk 27 of the parking assistance system 1 prestores information regarding the position, direction, image-capturable area, and the like of each of the cameras with respect to the vehicle 30.

For example, as illustrated in FIG. 3, an image having an angle of view of about 180 degrees centered around the front-side camera 5a, which is an area a, is input from the front-side camera 5a. Similarly, an image of an area b is input from the right-side camera 5b, an image of an area c is input from the left-side camera 5c, and an image of an area d is input from the rear-side camera 5d.

The generation unit 3a realized by the CPU 23 generates an overhead-view image around the vehicle 30 as seen from a predetermined viewpoint position recorded in the viewpoint data 27c, in accordance with the images input from the front-side camera 5a, the right-side camera 5b, the left-side camera 5c, and the rear-side camera 5d (operation S405).

For example, an overhead-view image as seen from the viewpoint position represented by viewpoint data (x01, y01, z01) of a viewpoint ID “01” illustrated in FIG. 8 is generated in accordance with the images of the areas a, b, c, and d illustrated in FIG. 3. Here, the viewpoint data (x01, y01, z01) of the viewpoint ID “01” is used because the viewpoint data (x01, y01, z01) of the viewpoint ID “01” is a default to which the flag “1” representing the current pointer is recorded in the viewpoint data 27c.

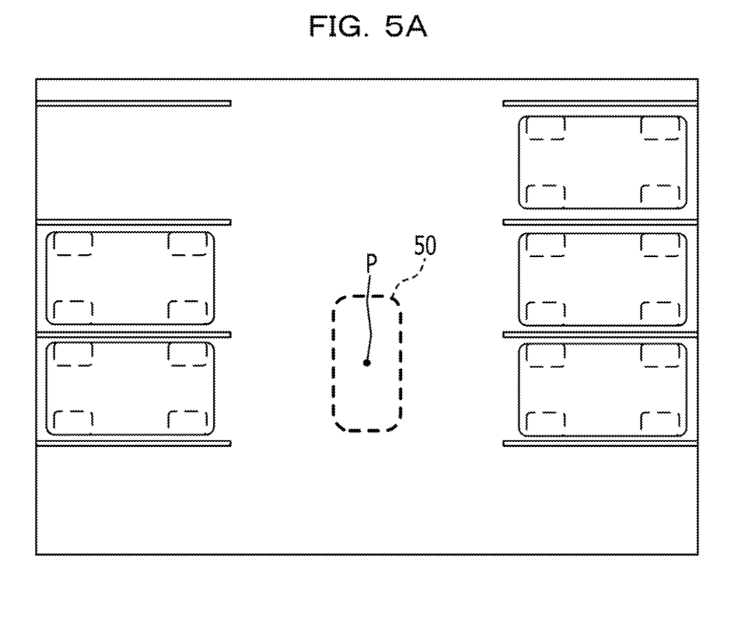

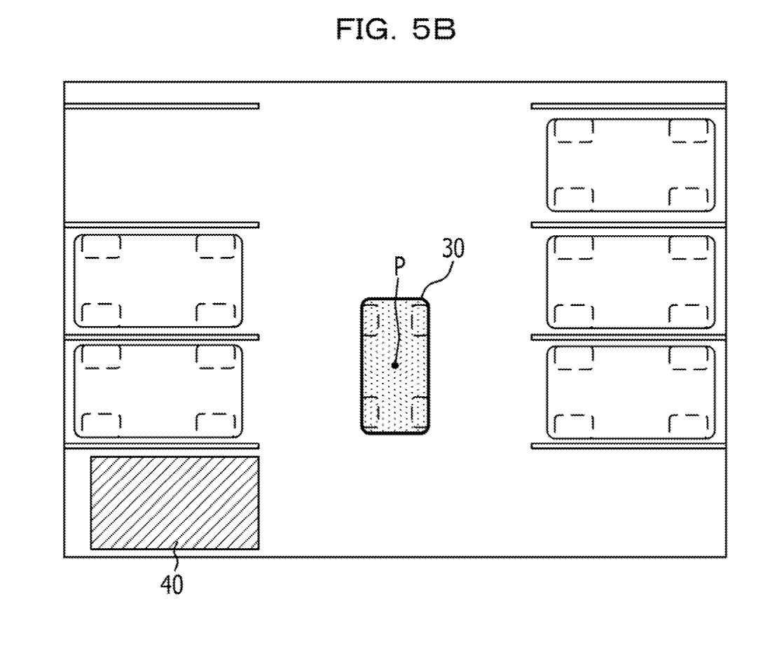

Moreover, the viewpoint ID “01” represents a viewpoint at a predetermined position above the center P (FIG. 3) of the vehicle 30, and thus an overhead-view image as illustrated in FIG. 5A is generated. In FIG. 5A, an area 50 represents the current position of the vehicle 30, and the vehicle 30 is not displayed in the overhead-view image. This is because none of the above-described front-side camera 5a, right-side camera 5b, left-side camera 5c, and rear-side camera 5d may capture an image of the vehicle 30. In order to compensate for this point, the image data 27d that has been recorded in advance by the following processing is superimposed on the overhead-view image and the resulting image is displayed.

If the driver of the vehicle 30 has not yet pressed the completion button 9b (FIG. 1) (NO in operation S407), the output unit 3b realized by the CPU 23 superimposes the subject-vehicle image and the parking space figure on the overhead-view image (operation S409). For example, FIG. 5B illustrates an example of the overhead-view image on which the image of the vehicle 30 and a parking space FIG. 40 have been superimposed. In FIG. 5B, the image of the vehicle 30 and the parking space FIG. 40 having a rectangular shape are superimposed on the overhead-view image and the resulting image is displayed. Here, the shape of the parking space FIG. 40 is not limited to a rectangular shape as long as the shape may be recognized by the driver.

In the following, processing in which the subject-vehicle image and the parking space figure are superimposed on the overhead-view image will be specifically described. First, the CPU 23 acquires the image of the vehicle 30 prerecorded in the image data 27d in the hard disk 27. For example, the image whose filename is “mycar01.jpg” corresponding to the viewpoint ID “01” in FIG. 10 is superimposed on the overhead-view image. Here, the image recorded in the image data 27d is an image used to identify the vehicle 30 in the overhead-view image, and thus it is desirable that the image be similar to the actual vehicle 30.

Next, the CPU 23 acquires coordinate positions of the parking space figure data to which the current pointer is set in the figure data 27e in the hard disk 27. Here, as illustrated in FIG. 9, the parking space figure data includes coordinate positions of four vertices of a rectangle representing the parking space figure. Each viewpoint ID is related to parking methods, and coordinate positions where the parking space figure is displayed are recorded for the individual parking methods having the viewpoint IDs. The parking methods will be described later. For example, in FIG. 9, a record 91, which is parking space figure data in which “1” is recorded in the current pointer, is acquired. It is desirable that the parking space FIG. 40 be as large as or larger than the actual size (the length and width) of the image of the vehicle 30.

The output unit 3b realized by the CPU 23 superimposes the subject-vehicle image and the parking space FIG. 40 recognized as described above on the overhead-view image generated in the above-described operation S405 (operation S409). For example, the subject-vehicle image is superimposed at the position of the area 50 illustrated in FIG. 5A and the parking space FIG. 40 is superimposed at a predetermined position a predetermined distance away from the area 50 in the overhead-view image. FIG. 5B illustrates an example of the overhead-view image on which the image of the vehicle 30 and the parking space FIG. 40 have been superimposed in operation S409. In FIG. 5B, the image of the vehicle 30 is superimposed at the center P of the overhead-view image (at a position at the center P of the area 50 illustrated in FIG. 5A). Moreover, the parking space FIG. 40 is superimposed on the overhead-view image at a position a predetermined distance away from the vehicle 30.

The above-described parking assistance apparatus 3 may output the parking space FIG. 40 at a position corresponding to movement characteristics of the vehicle 30. As a result, the driver may drive the vehicle 30 easily to a predetermined position that is more appropriate and may perform a parking operation with high accuracy.

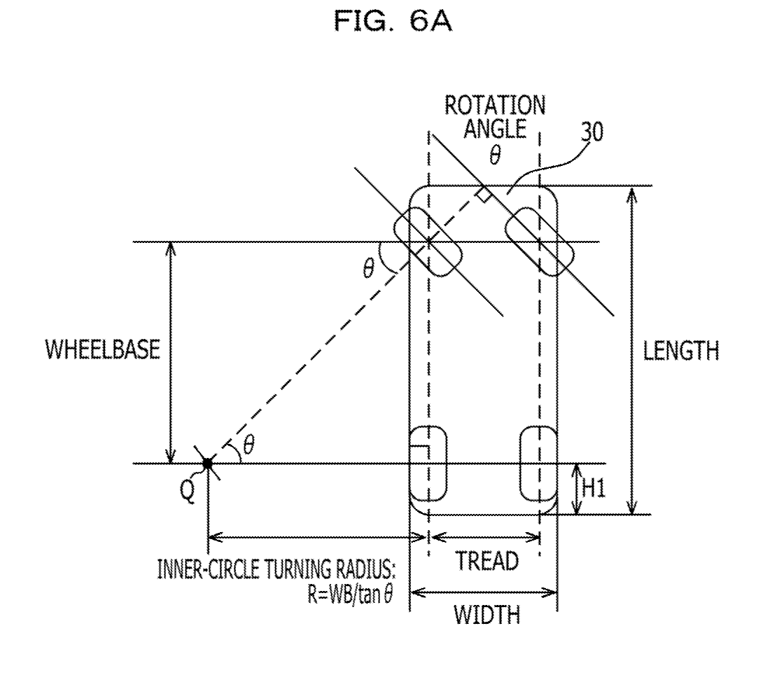

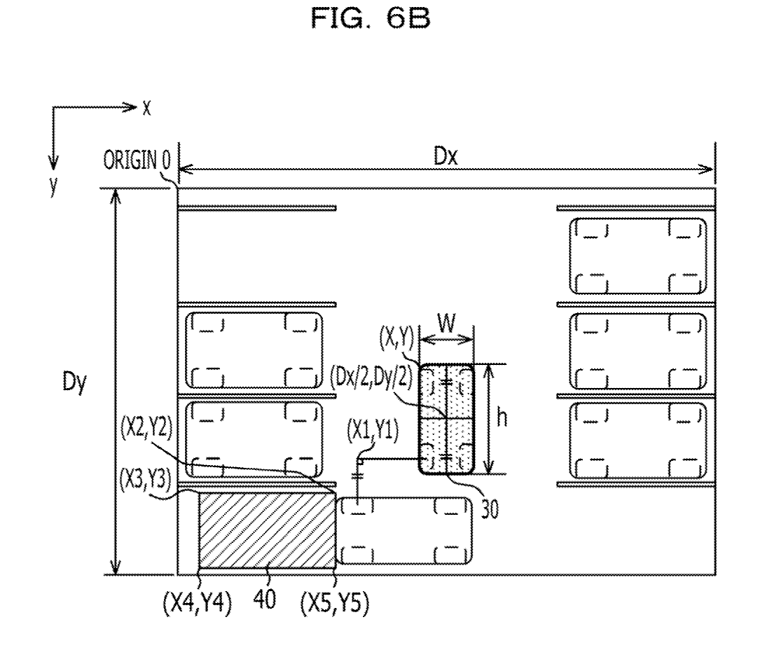

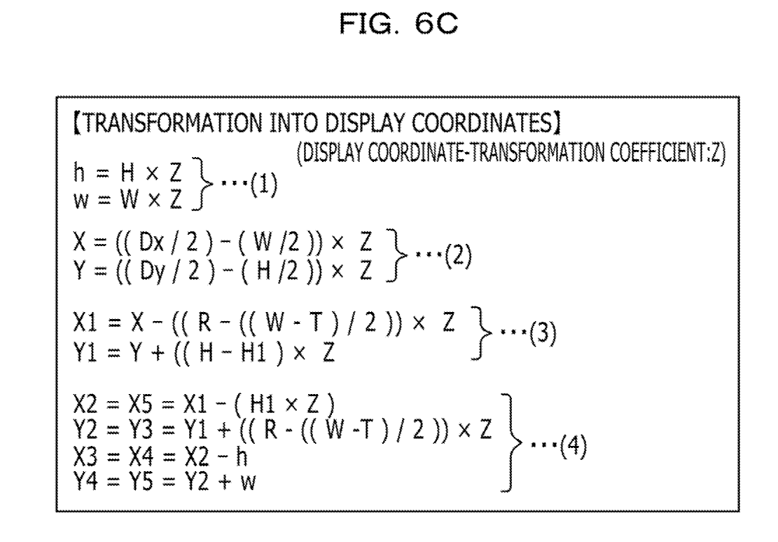

FIGS. 6A, 6B, and 6C are diagrams illustrating an example of calculation for determining a “position a predetermined distance away from the vehicle 30” on which the parking space FIG. 40 is superimposed. FIG. 6A illustrates the actual size of the vehicle 30. FIG. 6B illustrates the size of the vehicle 30 in an overhead-view image. FIG. 6C illustrates equations expressing the example of calculation. Here, the “position a predetermined distance away from the vehicle 30” is obtained by the following procedure. Here, Z denotes a display coordinate-transformation coefficient used when coordinate transformation is performed from a coordinate space in which the actual size of the vehicle 30 or the like is illustrated to a coordinate space having the same coordinate system as the overhead-view image. In the following, in the overhead-view image of FIG. 6B, description will be made by treating the upper left corner as the origin 0. In the following, the calculation will be performed by using the length H and width W, a wheelbase WB, a tread T, a rotation angle θ of a front wheel (hereinafter referred to as a front-wheel rotation angle θ, a distance H1 from the rear end of the vehicle 30 to the center of a rear wheel, and an inner-circle turning radius R of the vehicle 30 recorded in the vehicle data 27f and a display coordinate-transformation coefficient Z and the like.

First, the length h and width w of the vehicle 30 in the overhead-view image are obtained. For example, the length h (h=H×Z) and width w (w=W×Z) are obtained by multiplying each of the actual length H and width W of the vehicle 30 illustrated in FIG. 6A by the display coordinate-transformation coefficient Z.

Second, reference-point coordinates (X, Y) of the vehicle 30 in the overhead-view image are obtained. For example, the vehicle 30 is superimposed on the overhead-view image of FIG. 6B in the center thereof and displayed, and thus the center of the overhead-view image matches the center of the vehicle 30. Thus, by using the actual, horizontal width Dx and vertical width Dy of an area displayed by the overhead-view image, the actual width W and length H of the vehicle 30, the reference-point coordinates (X, Y) of the vehicle 30 in an overhead coordinate system are obtained as follows:

X=(Dx/2−W/2)×Z

Y=(Dy/2−H/2)×Z

Third, the center coordinates (X1, Y2) of inner-circle rotation of the vehicle 30 in the overhead-view image are obtained. Hereinafter, the center coordinates (X1, Y2) of inner-circle rotation are referred to as inner-circle rotation center coordinates (X1, Y2). Here, the center of inner-circle rotation is a center position of a circle that is the path taken by the center of a rear wheel of the vehicle 30 when the vehicle 30 reverses with the steering wheel turned to the utmost limit. For example, the length from the left exterior side surface of the vehicle 30 illustrated in FIG. 6A to the center of a left rear wheel is “(W−T)/2”, and thus, the length from the center Q of inner-circle rotation to the exterior side surface of the left rear wheel is “R−(W−T)/2”. Here, R denotes the actual inner-circle turning radius of the vehicle 30 and is obtained in accordance with “R=WB/tanθ” by using the wheelbase WB and front-wheel rotation angle θ of the vehicle 30. Here, it is desirable that R denote the minimum inner-circle turning radius. Thus, X1 of the inner-circle rotation center coordinates (X1, Y1) of the vehicle 30 in the overhead-view image of FIG. 6B is obtained in accordance with “X1=X−(R−(W−T)/2)×Z” by using the reference-point coordinates (X, Y).

On the other hand, Y1 of the inner-circle rotation center coordinates (X1, Y1) is obtained in accordance with “Y1=Y+(H−H1)×Z” by using the length H of the vehicle 30 and the distance H1 from the rear end of the vehicle 30 to the center of a rear wheel.

Fourth, vertex coordinates (X2, Y2), (X3, Y3), (X4, Y4), and (X5, Y5) of the parking space FIG. 40 in the overhead-view image are obtained. Here, X2 and X5 are obtained in accordance with “X2=X5=X1−H1×Z” by using X1 of the inner-circle rotation center coordinates (X1, Y1) and the distance H1 from the rear end of the vehicle 30 to the center of a rear wheel.

Next, Y2 and Y3 are obtained in accordance with “Y2=Y3=Y1+(R−(W−T)/2)×Z” by using Y1 of the inner-circle rotation center coordinates (X1, Y1) and the length “R−(W−T)/2” from the center Q of inner-circle rotation to the exterior side surface of the left rear wheel.

Next, X3, X4, Y4, and Y5 are obtained in accordance with “X3=X4=X2−h” and “Y4=Y5=Y2+w” by using the vertex coordinates (X2, Y2).

As described above, the position at which the parking space FIG. 40 is displayed is determined by characteristic values such as the length, width, wheelbase, tread, and the like of the vehicle 30. Here, a result, which is one of results calculated in advance in accordance with characteristic values and the like of vehicle data and stored as coordinate positions where parking space figure data is to be displayed as illustrated in FIG. 9, may be read and used as the position as desired, or the position may be calculated by using the characteristic values of the vehicle data on an as-desired basis.

The output unit 3b realized by the CPU 23 outputs the overhead-view image, which is generated and on which superimposition is performed as described above, to the display 21, that is, the display apparatus 7 (operation S413). As a result, the driver may observe the overhead-view image on which the subject-vehicle image and the parking space FIG. 40 have been superimposed.

In FIG. 4, if the viewpoint changing button 9c and the parking-method changing button 9d have not yet been pressed (NO in operation S415 and NO in operation S419), the CPU 23 may repeatedly execute processing in the above-described operations S401 to S413 until it is determined that the procedure is terminated (NO in operation S423). For example, processing may be repeatedly executed at predetermined intervals. Here, a determination as to whether the procedure is terminated may by performed in accordance with interrupt handling processing or termination processing of a predetermined program.

In the functional block diagram of FIG. 1, the “generation unit 3a” has a function of performing processing of operation S405 illustrated in FIG. 4. The “output unit 3b” has a function of performing processing of operations S409, S411, and S413 illustrated in FIG. 4. The “viewpoint changing unit 3c” has a function of performing processing of operations S405, S415, and S417 illustrated in FIG. 4. The “shape-changing unit 3d” has a function of performing processing of operations S409, S415, and S417 illustrated in FIG. 4. The “parking-method changing unit 3e” has a function of performing processing of operations S419 and S421 illustrated in FIG. 4.

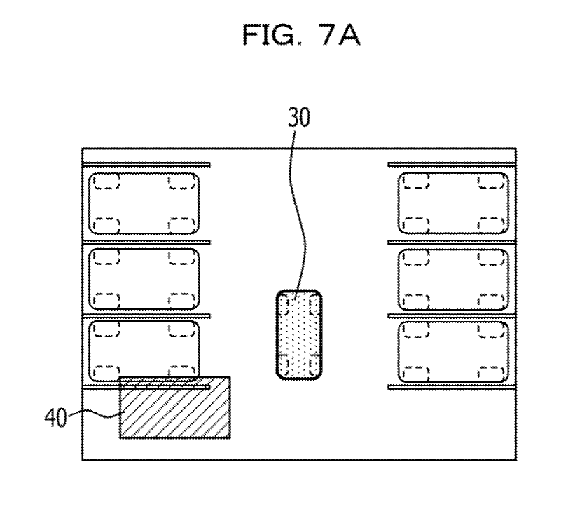

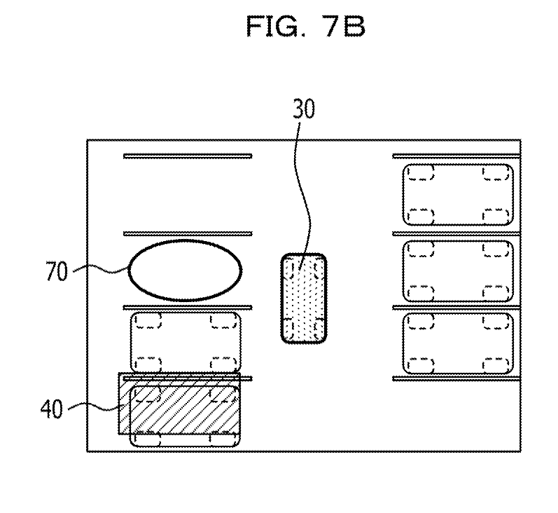

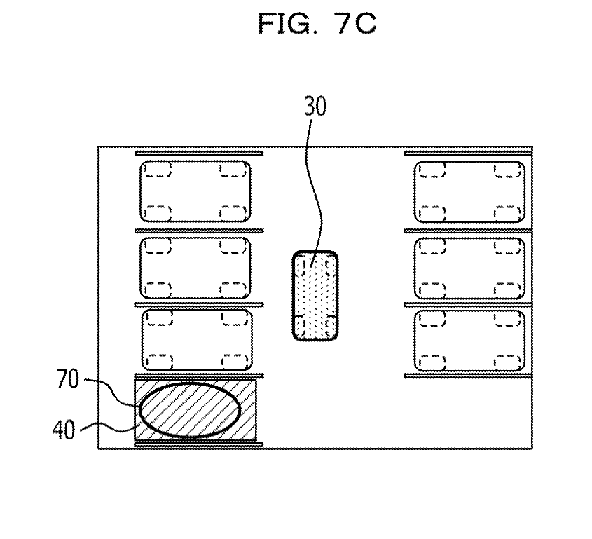

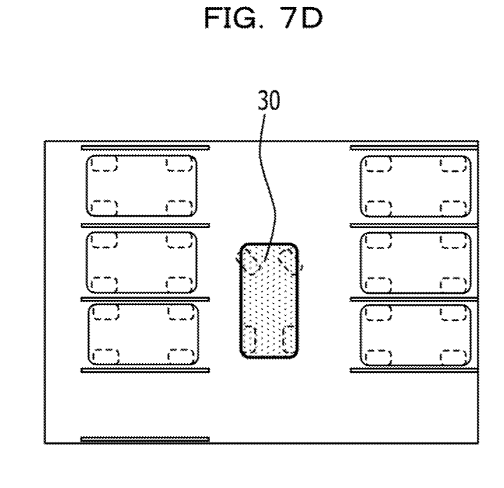

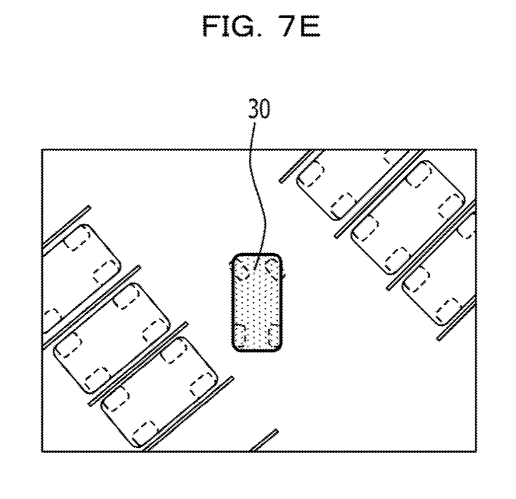

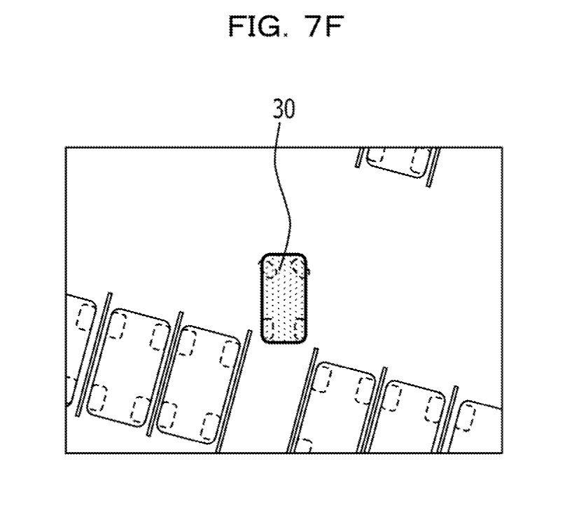

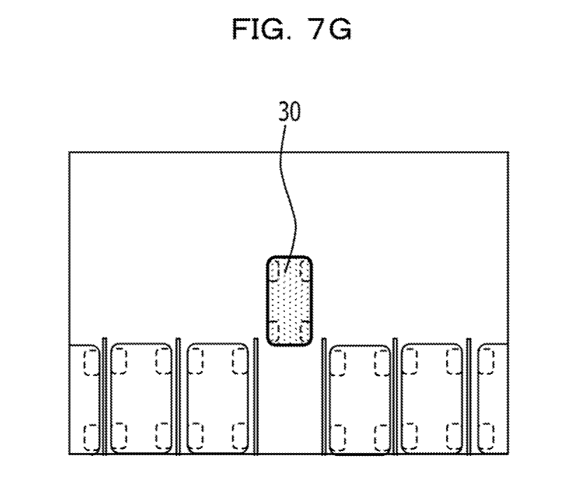

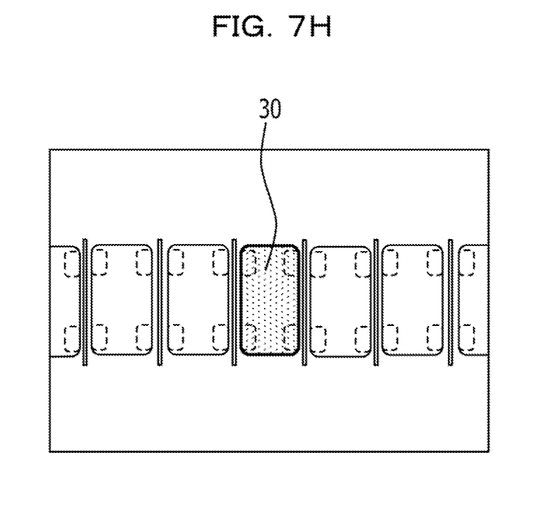

In a case in which the driver actually performs a parking operation, an example in which an overhead-view image on which the subject-vehicle image and the parking space FIG. 40 have been superimposed and displayed on the display 21 in the above-described operation S413 is used will be described. FIGS. 7A to 7H are diagrams illustrating in time sequence an example in which an overhead-view image is used.

For example, an overhead-view image as illustrated in FIG. 7A is displayed on the display 21 by the above-described processing (operations S401 to S413 in FIG. 4). Since this overhead-view image is updated at predetermined intervals, the overhead-view image changes as the vehicle 30 moves. However, the vehicle 30 is always displayed at the center of the overhead-view image. Therefore, the parking space FIG. 40 is also displayed at a predetermined fixed position a predetermined distance away from the vehicle 30 behind and to the left of the vehicle 30.

When the driver drives the vehicle 30 and finds a target parking position 70 illustrated in FIG. 7B, the driver drives the vehicle 30 in such a manner that the parking space FIG. 40 overlaps the target parking position 70. Here, the target parking position 70 is something the driver recognizes in the real world, and thus the target parking position 70 is not displayed on the display 21.

FIG. 7C illustrates a state in which the parking space FIG. 40 overlaps the target parking position 70, which the driver recognizes. In the state illustrated in FIG. 7C, when the driver operates and presses the completion button 9b (YES in operation S407), the output unit 3b realized by the CPU 23 superimposes just the subject-vehicle image on the overhead-view image, that is, the output unit 3b does not superimpose the parking space FIG. 40 on the overhead-view image (operation S411). As a result, the parking space FIG. 40 is deleted from the overhead-view image displayed on the display 21 whose display is updated at predetermined intervals.

Here, the position at which the vehicle 30 is stopping in FIG. 7C is an appropriate, predetermined position where the vehicle 30 typically stops at an initial point in time when a parking operation is performed. That is, the driver may easily drive the vehicle 30 to the appropriate, predetermined position by driving the vehicle 30 in such a manner that the parking space FIG. 40 overlaps the target parking position 70 in the overhead-view image.

When the driver presses the completion button 9b, the driver starts operation for parking the vehicle 30 onto the target parking position 70. For example, as illustrated in FIG. 7D, the steering wheel of the vehicle 30 is turned left, and reverse driving is started to reverse the vehicle 30. Here, in a case in which a position at which the parking space FIG. 40 is displayed has been calculated in accordance with the minimum inner-circle turning radius R, the driver may easily park the vehicle 30 onto the target parking position 70 by turning the steering wheel of the vehicle 30 left.

When reverse driving of the vehicle 30 is performed, the CPU 23 may repeatedly perform processing similar to the above-described operations S403 to S407, S411, and S413. Thus, as illustrated in FIGS. 7D to 7H, the overhead-view image of the surroundings of the vehicle 30 is updated as the vehicle 30 moves. Here, in this case, as illustrated in FIGS. 7D to 7H, the parking space FIG. 40 is not displayed on the display 21.

The driver of the vehicle 30 maintains a state in which the steering wheel is turned to the left until the vehicle 30 is in the state illustrated in FIG. 7G. Then, as illustrated in FIG. 7H, the driver may park the vehicle 30 onto the target parking position 70 with high accuracy by returning the steering wheel to a home position.

The parking assistance apparatus 3 may change the viewpoint position from which the overhead-view image is seen. The parking assistance apparatus 3 may change the shape of the parking space FIG. 40 in accordance with the position of a viewpoint that has been changed from the viewpoint by the viewpoint changing unit 3c. As a result, the driver may easily recognize the vehicle 30 and the target parking position 70 in the overhead-view image.

In the above-described description, an example in which parking assistance is performed by using the overhead-view image as seen from the viewpoint at a predetermined position above the center P of the vehicle 30 has been described. However, the viewpoint used in a parking assistance apparatus according to the present invention is changeable.

In operation S415 in FIG. 4, if the viewpoint changing unit 3c realized by the CPU 23 determines that the driver operates and presses the viewpoint changing button 9c (FIG. 2), the viewpoint changing unit 3c performs processing for changing viewpoint data and the parking space figure data and subject-vehicle image data, which are for being superimposed on the overhead-view image (operation S417).

For example, the position of a current pointer in the above-described viewpoint data 27c, figure data 27e, and image data 27d is changed in accordance with the value of a viewpoint ID corresponding to the viewpoint changing button 9c. More specifically, if the viewpoint ID input by the viewpoint changing button 9c is “02” that is a viewpoint behind and to the left of the vehicle 30, the current pointer in the viewpoint data 27c is changed from a record 81 to a record 82 (as illustrated in FIG. 8). As a result, an overhead-view image as seen from “02” is generated in overhead-view image generation processing of the above-described operation S405.

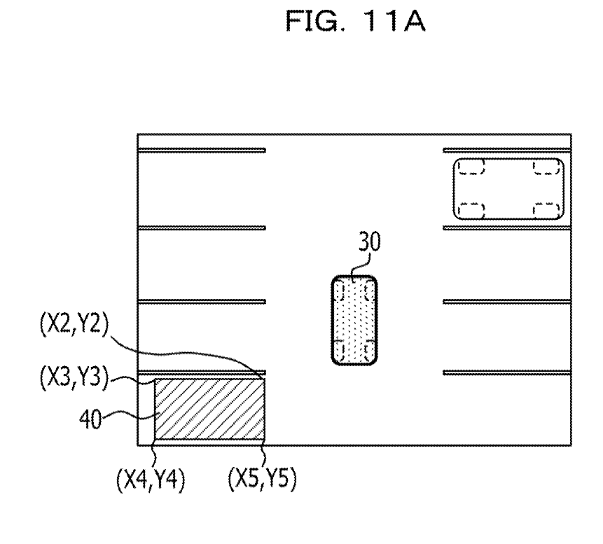

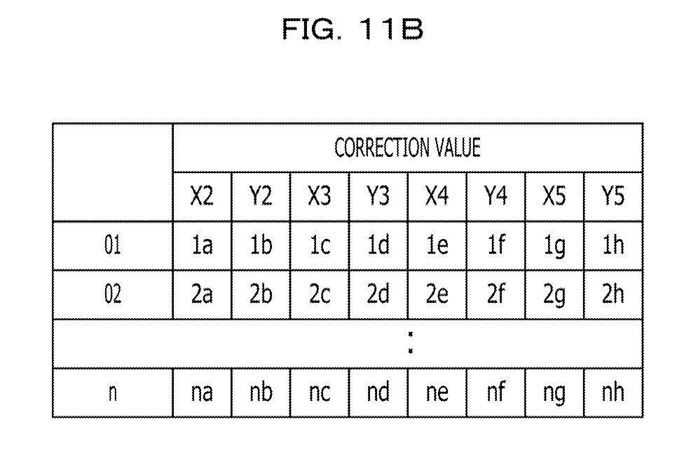

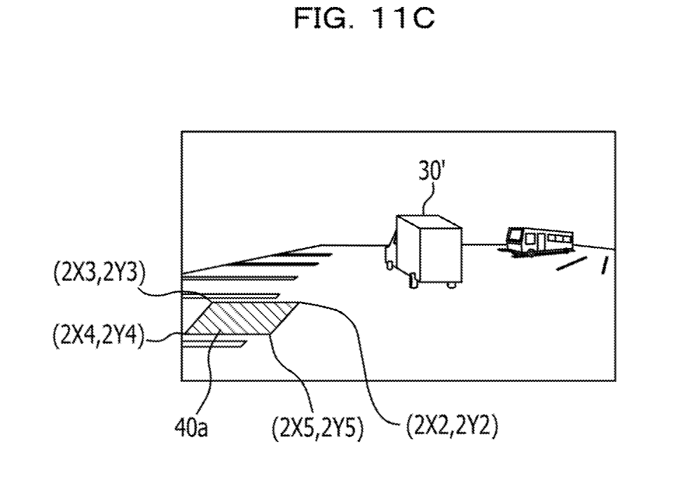

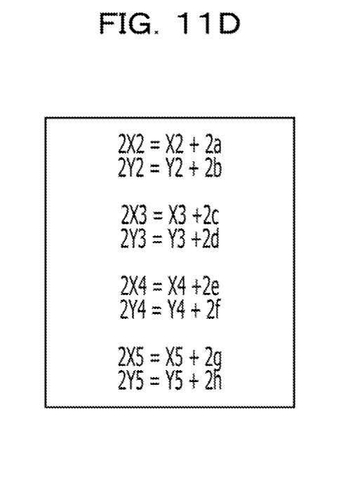

Moreover, as the viewpoint from which the overhead-view image is seen is changed, it is also desirable that the shape of the parking space FIG. 40 be changed. Accordingly, the shape-changing unit 3d realized by the CPU 23 changes the current pointer in the figure data 27e from the record 91 to a record 92 (as illustrated in FIG. 9). As a result, a parking space figure as seen from “02” is superimposed on the overhead-view image in parking space figure superimposition processing of the above-described operation S409. For example, in this case, the viewpoint from which the overhead-view image illustrated in FIG. 11A is seen is changed and a parking space FIG. 40a is displayed in the overhead-view image illustrated in FIG. 11C.

Moreover, as the viewpoint from which the overhead-view image is seen is changed, it is also desirable that the shape of the subject-vehicle image be changed. Accordingly, the shape-changing unit 3d realized by the CPU 23 changes the current pointer in the image data 27d from a record 101 to a record 102 (as illustrated in FIG. 10). As a result, the subject-vehicle image “mycar02.jpg” as seen from “02” is superimposed on the overhead-view image in subject-vehicle-image superimposition processing in the above-described operations S409 and S411. For example, in this case, the viewpoint from which the overhead-view image illustrated in FIG. 11A is seen is changed and a vehicle 30′ is displayed in the overhead-view image illustrated in FIG. 11C.

Here, a method for generating the figure data 27e in FIG. 9 will be described with reference to FIGS. 11A to 11D. For example, a case in which the parking space FIG. 40 illustrated in FIG. 11A is changed to the parking space FIG. 40a illustrated in FIG. 11C is considered. In the viewpoint data 27c illustrated in FIG. 8, it is assumed that the viewpoint of FIG. 11A is “01” and the viewpoint of FIG. 11C is “02”. Pixels made up of FIG. 11A may be changed to pixels made up of FIG. 11C by using a correction-value table as illustrated in FIG. 11B. Thus, vertices in FIG. 11C may be calculated by adding correction values of “02” illustrated in FIG. 11B to vertices (X2, Y2), (X3, Y3), (X4, Y4), and (X5, Y5) of the parking space FIG. 40 in FIG. 11A. More specifically, the vertices of the parking space FIG. 40a in FIG. 11C are expressed by (2X2, 2Y2), (2X3, 2Y3), (2X4, 2Y4), and (2X5, 2Y5) as illustrated in FIG. 11D.

The parking assistance apparatus 3 may allow a parking method for parking the vehicle 30 to be specified. Moreover, the parking assistance apparatus 3 may change the shape of the parking space FIG. 40 in accordance with the specified parking method. As a result, the driver may select a parking method in accordance with a desired parking position and a parking space figure corresponding to the selected parking method may be displayed in the overhead-view image.

An example in which the parking space FIG. 40 for performing parking in which the vehicle 30 reverses in a direction to the left and the back is displayed to assist with parking has been described with reference to FIGS. 7A to 7H.

In operation S419 in FIG. 4, if the parking-method changing unit 3e realized by the CPU 23 determines that the driver operates and presses the parking-method changing button 9d, the parking-method changing unit 3e performs processing for changing the parking space figure data (operation S421).

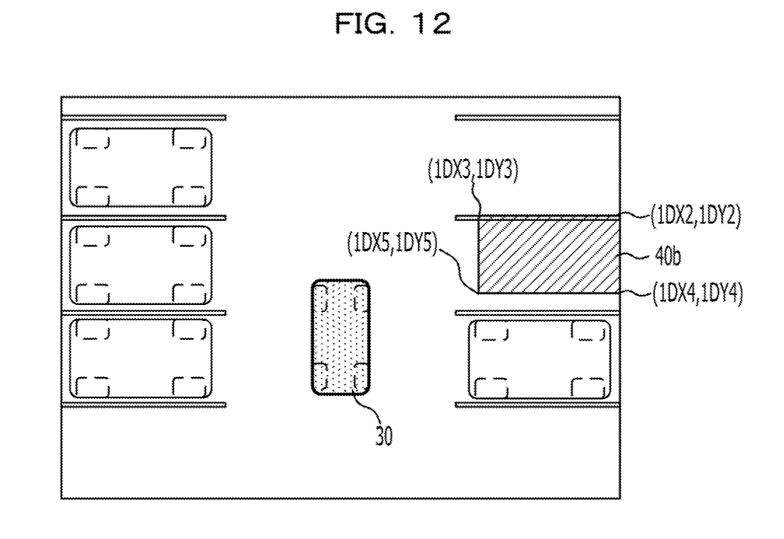

For example, the position of the current pointer in the above-described figure data 27e is changed in accordance with a parking method corresponding to the parking-method changing button 9d. More specifically, if the parking-method changing button 9d corresponds to the vehicle 30 being driven to perform “parking in which the vehicle is driven forward in a direction to the right and the front”, the current pointer in the figure data 27e is changed from a record 91 to a record 93 (illustrated in FIG. 9). As a result, in the parking space figure superimposition processing of the above-described operation S409, a parking space figure is superimposed at a position corresponding to the current parking method after the parking method has been changed. For example, if the parking-method changing button 9d corresponds to the vehicle 30 being driven to perform “parking in which the vehicle is driven forward in a direction to the right and the front”, as illustrated in FIG. 12, a parking space FIG. 40b is displayed at a position where coordinate positions of the record 93 in the figure data 27e (the left front position (1DX2, 1DY2), the left rear position (1DX3, 1DY3), the right front position (1DX4, 1DY4), and the right rear position (1DX5, 1DY5)) are treated as the vertices.

As described above, the driver may drive the vehicle 30 in which the parking assistance system 1 is mounted easily to a predetermined position which is an appropriate position for starting a parking operation for the vehicle 30. Then, the driver starts the parking operation for the vehicle 30 from the predetermined position, which has a high percentage of success of parking, and may easily park the vehicle 30 onto the target parking position 70 with high accuracy.

The output unit 3b of the parking assistance apparatus 3 may output the parking space FIG. 40 at a position onto which the vehicle 30 may be parked by moving along a path at the minimum turning radius. As a result, the driver may drive the vehicle 30 to a predetermined position by driving the vehicle 30 minimally in accordance with the parking space FIG. 40 displayed at a position where the vehicle 30 may be parked.

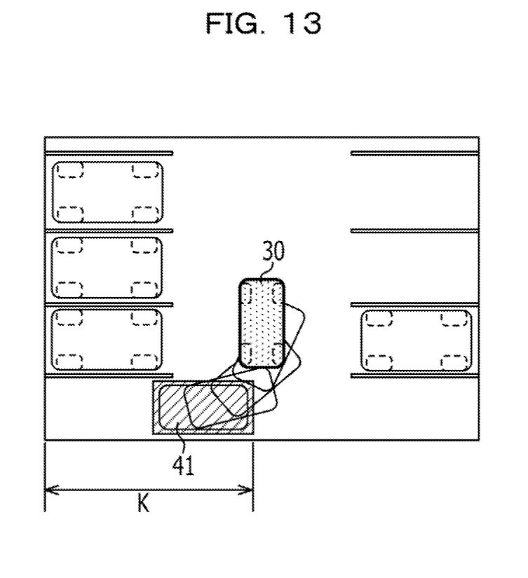

FIG. 6B illustrates an example in which the parking space FIG. 40 is displayed at a position the vehicle 30 will reach after the vehicle 30 reverses with the inner-circle turning radius R until the vehicle 30 is rotated by 90 degrees with respect to a predetermined position and then reverse straight. However, as illustrated in FIG. 13, the output unit 3b may display a parking space FIG. 41 at a position the vehicle 30 will reach when the vehicle 30 is rotated by 90 degrees with respect to an initial stop position.

In this case, a position the vehicle 30 will reach after the vehicle 30 reverses with the minimum inner-circle turning radius is treated as the target parking position 70, and the driver performs a parking operation while observing the parking space FIG. 41. Thus, even when the parking space is narrow and small, the parking space FIG. 41 may be placed onto the target parking position 70.

Here, the display position of the parking space FIG. 41 may be changed within a predetermined range K on the display 21. As a result, the driver may fine-tune the display position of the parking space FIG. 41 and user-friendliness is improved.

In the parking assistance apparatus 3, the parking space FIG. 40 may be made up of a plurality of frames which are larger than the outline shape of the size of the vehicle 30 and whose sizes are different. As a result, the driver may drive the vehicle 30 to an initial stop position in accordance with a parking space figure corresponding to a percentage of success of parking.

FIG. 5B illustrates an example in which the output unit 3b superimposes the parking space FIG. 40 having a rectangular shape on the overhead-view image and the resulting image is displayed; however, the parking space FIG. 40 may be displayed by another method. For example, the parking space FIG. 40 may be displayed by using two rectangular shapes that are different in size.

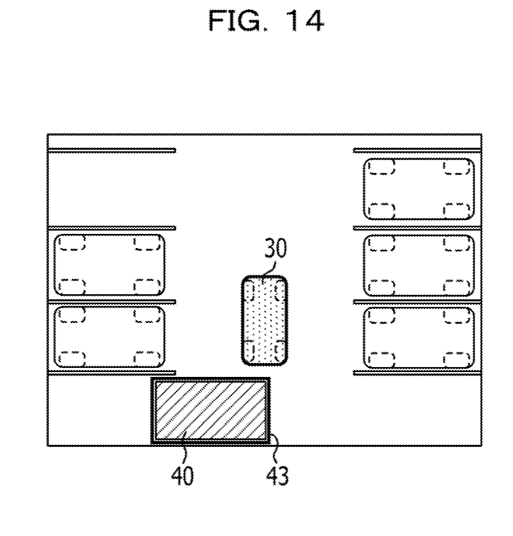

FIG. 14 is a diagram of an example in which a first parking space FIG. 40 and a second parking space FIG. 43 are displayed as parking space figures. For example, the second parking space FIG. 43, which is larger than the first parking space FIG. 40, may be displayed at a position 50 cm (a measured value) away from each side of the first parking space FIG. 40. As a result, the driver may recognize the first parking space FIG. 40, which is a smaller one, as a minimum parking space for parking the vehicle 30. In addition, the driver may recognize the second parking space FIG. 43, which is a larger one, as a parking space into which the vehicle 30 may be safely parked. As a result, the driver may select a parking space figure used for parking assistance in accordance with the level of driving-operation skills of the driver, and user-friendliness is improved.

In the above-described embodiments, parking space figure data corresponding to a viewpoint ID based on the viewpoint data 27c illustrated in FIG. 8 is selected; however, coordinate positions of parking space figure data may be calculated on an as-desired basis in accordance with a correction-value table as illustrated in FIG. 11B. Especially when the driver may arbitrarily change the viewpoint position, it is desirable that coordinate positions of parking space figure data be calculated on an as-desired basis.

In the above-described embodiments, an example in which the position of the parking space figure is changed in accordance with the coordinate positions in the figure data 27e and displayed has been described. However, the viewpoint from which the overhead-view image is seen may be enhanced in accordance with a parking method. For example, compared with “parking in which the vehicle reverses in a direction to the right and the back” and “parking in which the vehicle reverses in a direction to the left and the back”, when “parking in which the vehicle is driven forward in a direction to the right and the front” or “parking in which the vehicle is driven forward in a direction to the left and the front” is performed, the behavior of the vehicle 30 becomes larger for reasons of the difference between a track followed by front and back inner wheels when turning. Thus, it becomes easier to recognize the situation of the surroundings of the vehicle 30 by displaying an overhead-view image of a wider area, and improved user-friendliness for drivers is provided.

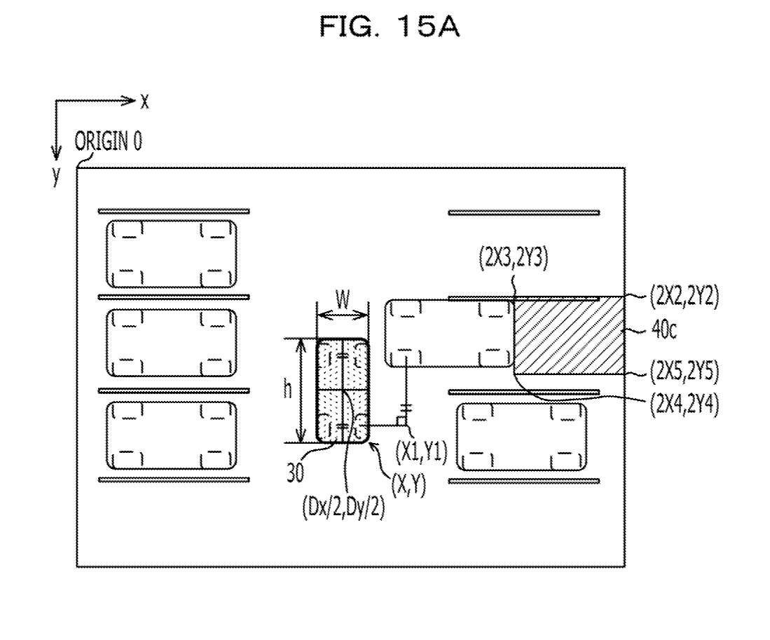

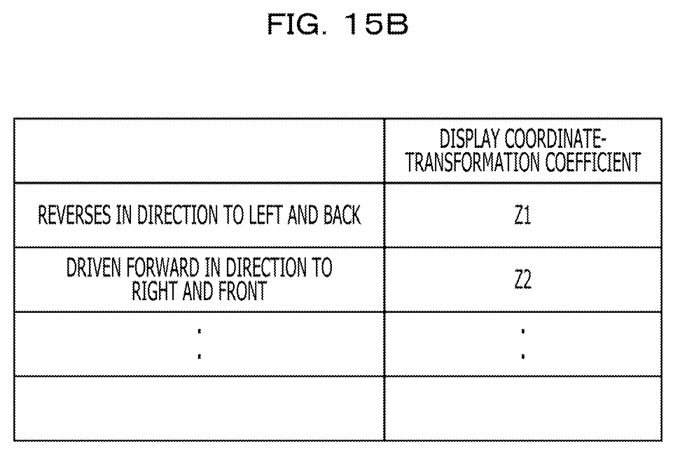

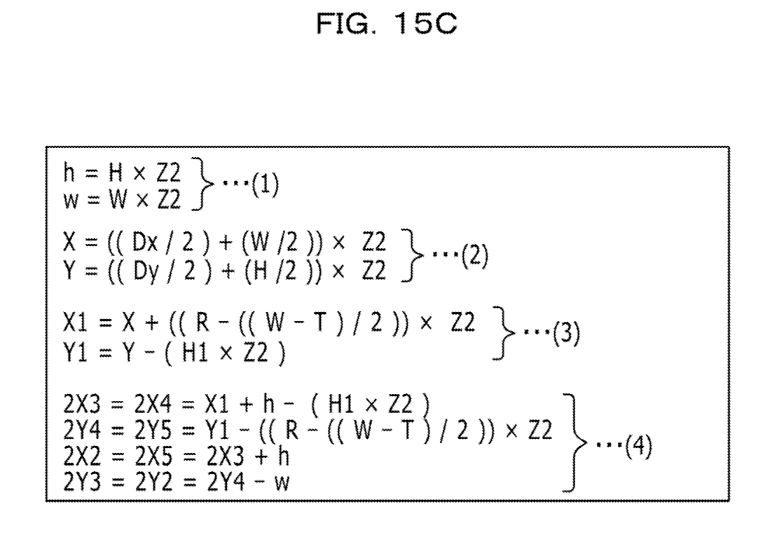

FIGS. 15A, 15B, and 15C are diagrams illustrating an example in which the viewpoint is enhanced so as to determine coordinates of vertices of a parking space figure when “parking in which the vehicle is driven forward in a direction to the right and the front” is performed. In this case, the “position a predetermined distance away from the vehicle 30” is obtained in the following procedure. Here, Z2 denotes a display coordinate-transformation coefficient used when “parking in which the vehicle is driven forward in a direction to the right and the front” is performed.

In the following, in an overhead-view image of FIG. 15A, description will be made by treating the upper left corner as the origin 0. In the following, calculation is performed similarly to FIG. 6A by using the length H and width W, the wheelbase WB, the tread T, the front-wheel rotation angle θ, the distance H1 from the rear end of the vehicle 30 to the center of a rear wheel, and the inner-circle turning radius R of the vehicle 30 recorded in the vehicle data 27f and the above-described display coordinate-transformation coefficient Z2.

First, the length h and width w of the vehicle 30 in the overhead-view image are obtained. For example, the length h (h=H×Z2) and width w (w=W×Z2) are obtained by multiplying each of the actual length H and width W of the vehicle 30 illustrated in FIG. 6A by the display coordinate-transformation coefficient Z2.

Second, reference-point coordinates (X, Y) of the vehicle 30 in the overhead-view image are obtained. For example, the vehicle 30 is superimposed on the overhead-view image of FIG. 15A in the center thereof and displayed, and thus the center of the overhead-view image matches the center of the vehicle 30. Thus, by using the actual, horizontal width Dx and vertical width Dy of an area displayed by the overhead-view image, and the actual width W and length H of the vehicle 30, the reference-point coordinates (X, Y) of the vehicle 30 in an overhead coordinate system are obtained as follows:

X=(Dx/2+W/2)×Z2

Y=(Dy/2+H/2)×Z2

Third, the inner-circle rotation center coordinates (X1, Y2) of the vehicle 30 in the overhead-view image are obtained. Here, the center of inner-circle rotation is a center position of a circle that is the path taken by the center of a right rear wheel of the vehicle 30 when the vehicle 30 goes forward with the steering wheel turned to the utmost limit. For example, the length from the right exterior side surface of the vehicle 30 illustrated in FIG. 6A to the center of a right rear wheel is “(W−T)/2”, and thus, the length from the center Q of inner-circle rotation to the exterior side surface of the right rear wheel is “R−(W−T)/2”. Here, R denotes the actual inner-circle turning radius of the vehicle 30 and is obtained in accordance with “R=WB/tanθ” by using the wheelbase WB and front-wheel rotation angle θ of the vehicle 30. Here, it is desirable that R denote the minimum inner-circle turning radius. Thus, X1 of the inner-circle rotation center coordinates (X1, Y1) of the vehicle 30 in the overhead-view image of FIG. 15A is obtained in accordance with “X1=X+(R−(W−T)/2)×Z2” by using the reference-point coordinates (X, Y).

On the other hand, Y1 of the inner-circle rotation center coordinates (X1, Y1) is obtained in accordance with “Y1=Y−H1×Z2” by using the length H of the vehicle 30 and the distance H1 from the rear end of the vehicle 30 to the center of a rear wheel.

Fourth, vertex coordinates (2X2, 2Y2), (2X3, 2Y3), (2X4, 2Y4), and (2X5, 2Y5) of a parking space FIG. 40c in the overhead-view image are obtained. Here, 2X3 and 2X4 are obtained in accordance with “2X3=2X4=X1+h−H1×Z2” by using X1 of the inner-circle rotation center coordinates (X1, Y1) and the distance H1 from the rear end of the vehicle 30 to the center of a rear wheel.

Next, 2Y4 and 2Y5 are obtained in accordance with “2Y4=2Y5=Y1−(R−(W−T)/2)×Z2” by using Y1 of the inner-circle rotation center coordinates (X1, Y1) and the length “R−(W−T)/2” from the center Q of inner-circle rotation to the exterior side surface of the right rear wheel.

Next, 2X2, 2X5, 2Y3, and 2Y2 are obtained in accordance with “2X2=2X5=2X3+h” and “2Y3=2Y2=2Y4−w” by using the vertex coordinates (2X3, 2Y4).

As described above, the position at which the parking space FIG. 40c is displayed is determined by characteristic values such as the length, width, wheelbase, tread, and the like of the vehicle 30. Here, a result, which is one of results calculated in advance in accordance with characteristic values and the like of vehicle data and stored as coordinate positions where parking space figure data is to be displayed as illustrated in FIG. 9, may be read and used as the position desired, or the position may be calculated by using the characteristic values and the like of the vehicle data on an as-desired basis.

In the above-described embodiments, each functional block illustrated in FIG. 1 is realized by processing performed by the CPU 23 that executes software. However, part of or all of the processing performed by the CPU 23 may be realized by hardware such as a logic circuit or the like. Here, furthermore, processing of part of a program may be performed by an operating system (OS).

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiment(s) of the present invention(s) has(have) been described in detail, it should be understood that the various changes, substitutions, and alterations could be made hereto without departing from the spirit and scope of the invention.

What is claimed is:

1. A parking assistance apparatus comprising:
a generation unit that generates an overhead-view image as seen from a predetermined viewpoint, in accordance with an image captured by at least one image capturing apparatus mounted in a vehicle; and
an output unit that superimposes, in a same coordinate system as the overhead-view image generated by the generation unit, an image of the vehicle on the overhead-view image and a predetermined figure at a position a predetermined distance away from the vehicle on the overhead-view image, and outputs the resulting overhead-view image to a display apparatus.

2. The parking assistance apparatus according to claim 1, wherein the output unit superimposes the image of the vehicle and the predetermined figure on the overhead-view image in such a manner that a relative-position relationship between the image of the vehicle and the predetermined figure in the overhead-view image matches a relative-position relationship between the vehicle and a target parking position in a real situation, and outputs the resulting overhead-view image.

3. The parking assistance apparatus according to claim 1, wherein the target parking position is calculated on an as-desired basis in accordance with a correction-value table.

4. The parking assistance apparatus according to claim 1, further comprising:
a viewpoint changing unit that changes a position of the predetermined viewpoint from which the overhead-view image is seen; and
a shape-changing unit that changes a shape of the predetermined figure in accordance with a position of a viewpoint that has been changed from the predetermined viewpoint by the viewpoint changing unit.

5. The parking assistance apparatus according to claim 1, further comprising:
a parking-method changing unit that specifies a parking method, wherein the shape-changing unit changes the shape of the predetermined figure in accordance with the parking method accepted by the parking-method changing unit.

6. The parking assistance apparatus according to claim 1, wherein the output unit outputs the predetermined figure to a position determined in accordance with movement characteristics of the vehicle.

7. The parking assistance apparatus according to claim 6, wherein the output unit outputs the predetermined figure to a position determined in accordance with a minimum turning radius of the vehicle.

8. The parking assistance apparatus according to claim 6, wherein the predetermined figure includes a plurality of frames which are larger than an outline shape of the vehicle in the overhead-view image and whose sizes are different.

9. The parking assistance apparatus according to claim 1, wherein the position at which the predetermined figure is superimposed is determined by characteristic values of the vehicle.

10. The parking assistance apparatus according to claim 9, wherein the characteristic values include any one of a length, width, wheelbase, and tread.

11. A parking assistance system comprising:
a parking assistance apparatus;
at least one image capturing apparatus that captures an image of surroundings of a vehicle; and
a display apparatus that displays an image output from the parking assistance apparatus,
the parking assistance apparatus, the at least one image capturing apparatus, and the display apparatus being connected to one another via a network,
the parking assistance apparatus includes
a generation unit that generates an overhead-view image as seen from a predetermined viewpoint, in accordance with an image captured by the image capturing apparatus; and
an output unit that superimposes, in a same coordinate system as the overhead-view image generated by the generation unit, an image of the vehicle on the overhead-view image and a predetermined figure at a position a predetermined distance away from the vehicle on the overhead-view image and outputs the resulting overhead-view image.

12. The parking assistance system according to claim 11, further comprising a plurality of image capturing apparatuses,
wherein the generation unit generates the overhead-view image based on a plurality of images captured by the plurality of image capturing apparatuses, by mapping the plurality of images onto a surface of a predetermined figure, and calculating the overhead-view image by performing coordinate transformation as seen from a predetermined viewpoint.

13. A non-transitory computer-readable storage medium that stores a program for causing a computer to perform execution of at least:
generating an overhead-view image as seen from a predetermined viewpoint, in accordance with an image captured by at least one image capturing apparatus mounted on a vehicle; and
superimposing, in a same coordinate system as the overhead-view image, an image of the vehicle on the overhead-view image and a predetermined figure at a position a predetermined distance away from the vehicle on the overhead-view image and outputting the resulting overhead-view image to a display apparatus.

14. The non-transitory computer-readable storage medium according to claim 13, further causing the computer to perform execution of at least:
changing a position of the predetermined viewpoint from which the overhead-view image is seen; and
changing a shape of the predetermined figure in accordance with a position of a viewpoint that has been changed from the predetermined viewpoint.

15. The non-transitory computer-readable storage medium according to claim 13, further causing the computer to perform execution of at least:
specifying a parking method,
wherein the shape of the predetermined figure is changed in accordance with the parking method.

16. A method of assisting with parking comprising:
generating an overhead-view image as seen from a predetermined viewpoint, in accordance with an image captured by at least one image capturing apparatus mounted on a vehicle; and
superimposing, in the same coordinate system as the overhead-view image, an image of the vehicle on the overhead-view image and a predetermined figure at a position a predetermined distance away from the vehicle on the overhead-view image and outputting the resulting overhead-view image to a display apparatus.

17. The method according to claim 16, further comprising:
changing a position of the predetermined viewpoint from which the overhead-view image is seen; and
changing the shape of the predetermined figure in accordance with a position of a viewpoint that has been changed from the predetermined viewpoint.

18. The method according to claim 16, further comprising:
specifying a parking method,
wherein the shape of the predetermined figure is changed in accordance with the parking method.
